(19) United States
(12) Patent Application Publication
(10) Pub. No.: US 2014/0189640 A1
(43) Pub. Date: Jul. 3, 2014

(54) Native Language IDE Code Assistance

(71) Applicant: INTERNATIONAL BUSINESS MACHINES CORPORATION, Armonk, NY (US)

(72) Inventors: Lisa Seacat DeLuca, San Francisco, CA (US); Grant Douglas Miller, Arvada, CO (US)

(73) Assignee: International Business Machines Corporation, Armonk, NY (US)

(21) Appl. No.: 13/788,686

(22) Filed: Mar. 7, 2013

Related U.S. Application Data
(63) Continuation of application No. 13/733,390, filed on Jan. 3, 2013.

(51) Int. Cl. G06F 9/44

(52) U.S. Cl. CPC G06F 8/34
USPC 717/110

(57) ABSTRACT

An embodiment of the invention provides a method including receiving input from a user interface, wherein the input includes the name of a code segment in a first language. A database is queried with the name of the code segment in the first language to identify the name of the code segment in a second language different from the first language. The database includes names of code segments in a plurality of languages. The name of the code segment is displayed in the second language and/or the name of the code segment in the first language is replaced with the name of the code segment in the second language.

This patent application is a continuation application of U.S. patent application Ser. No. 13/733,390 filed on Jan. 3, 2013, which is hereby incorporated by reference.

### BACKGROUND

The present invention is in the field of systems, methods, and computer program products for native language integrated development environment (IDE) code assistance. Many application program interfaces have names of classes and methods that are somewhat descriptive in English (e.g., AlertType, AccelerometerData). Thus, a user looking for an existing class and/or method may be able to find the desired class and/or method if the user's first language is English. When developing code, a programmer often looks at references to determine which class to use or function to call. These typically have English names that reflect what the class or function does. Quickly scanning the list can tell the user which call to make.

### SUMMARY OF THE INVENTION

An embodiment of the invention provides a method including receiving input from a user interface, wherein the input includes the name of a code segment in a first language. A database is queried with the name of the code segment in the first language to identify the name of the code segment in a second language different from the first language. The database includes names of code segments in a plurality of languages. The name of the code segment is displayed in the second language and/or the name of the code segment in the first language is replaced with the name of the code segment in the second language.

Another embodiment of the invention provides a method where input in a first language is received from a user interface, wherein the input includes a description of a code segment and/or a function of the code segment. A database is queried with the input and/or translated input in a second language to identify the name of the code segment in the second language. The database includes names of code segments in a plurality of languages, descriptions of code segments in a plurality of languages, and/or functions of code segments in a plurality of languages. The name of the code segment is displayed in the second language and/or the input in the first language is replaced with the name of the code segment in the second language.

A method according to another embodiment of the invention receives input from a user interface, wherein the input includes the name of a code segment in a first language. The name of the code segment is translated from the first language to a second language different from the first language. A database is queried with the name of the code segment in the second language to identify the code segment and/or at least one related code segment, wherein the related code segment(s) have a threshold degree of similarity with the code segment. The name of the code segment in the second language and/or the name(s) of the related code segment(s) are displayed.

Yet another embodiment of the invention provides a method where input in a first language is received from a user interface, the input including a description of a code segment and/or a function of the code segment. A database is queried with the input and/or the translated input in a second language to identify the name of the code segment in the second language and/or name(s) of related code segments. The related code segment(s) have a threshold degree of similarity with the code segment. The database includes names of code segments in a plurality of languages, descriptions of code segments in a plurality of languages, and/or functions of code segments in a plurality of languages. The name of the code segment in the second language is displayed, the name(s) of the related code segment(s) are displayed, the input in the first language is replaced with the code segment in the second language, and/or the input in the first language is replaced with the related code segment.

### BRIEF DESCRIPTION OF THE SEVERAL VIEWS OF THE DRAWINGS

The present invention is described with reference to the accompanying drawings. In the drawings, like reference numbers indicate identical or functionally similar elements.

FIG. 1 is a flow diagram illustrating a method for native language integrated development environment (IDE) code assistance according to an embodiment of the invention;

FIG. 2 is a flow diagram illustrating a method for native language IDE code assistance according to another embodiment of the invention;

FIG. 3 is a flow diagram illustrating a method for native language IDE code assistance according to yet another embodiment of the invention;

FIG. 4 illustrates the English description for a code segment according to an embodiment of the invention;

FIG. 5 is a flow diagram illustrating a method for native language IDE code assistance according to still another embodiment of the invention;

FIG. 6 is a flow diagram illustrating a method for code segment translation according to an embodiment of the invention;

FIG. 7 illustrates a code snipet according to an embodiment of the invention;

FIG. 8 illustrates a description of a translated code segment according to an embodiment of the invention;

FIG. 9 illustrates a system for native language IDE code assistance according to an embodiment of the invention; and

FIG. 10 illustrates a computer program product according to an embodiment of the invention.

### DETAILED DESCRIPTION

Exemplary, non-limiting, embodiments of the present invention are discussed in detail below. While specific configurations are discussed to provide a clear understanding, it should be understood that the disclosed configurations are provided for illustration purposes only. A person of ordinary skill in the art will recognize that other configurations may be used without departing from the spirit and scope of the invention.

At least one embodiment of the invention includes a system and method to translate, as best as possible real-time code segments from a native language to a default development language by retrieving currently used code segments as closest match translations. Developers who know the name of a method or variable in their native language can enter input in their native language, and the system can determine the default development language translation to suggest a possible method or variable to use.

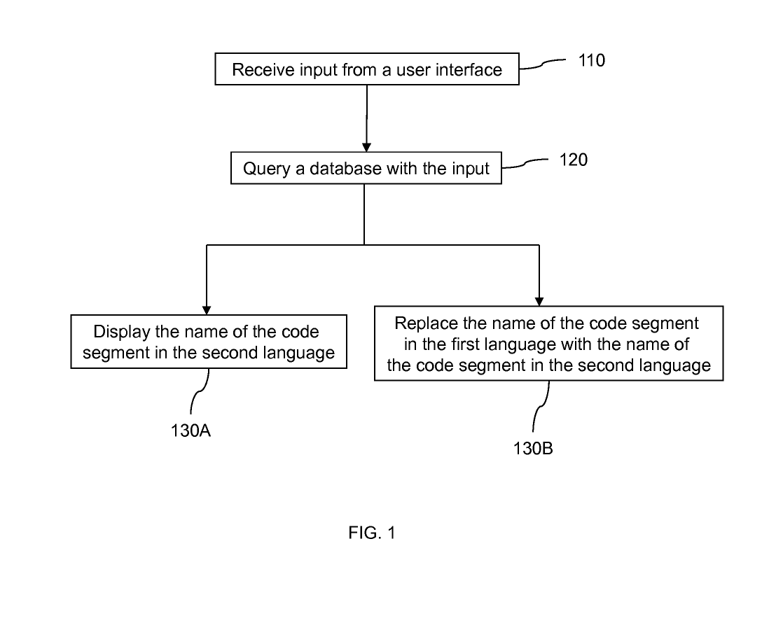

FIG. 1 is a flow diagram illustrating a method for native language integrated development environment (IDE) code assistance according to an embodiment of the invention. Input is received from a user interface 110, wherein the input includes the name of a code segment in a first language (also referred to herein as the “native language”). As used herein, the term “user interface” includes a hardware component for receiving input from a user. Examples of a user interface include, but are not limited to, a mouse, a keyboard, a touchscreen display, and a microphone. Moreover, the term “code segment” as used herein can include pre-written or pre-existing lines of code in a computer program. For example, the user can enter the text “AccelerometerData”, which is the name of a segment of code of a computer program that has already been written by another developer.

In at least one embodiment, the code segment is a class, which is a template definition of the methods and variable in an object. The term “object” as used herein includes an instance of a class containing real variables. The code segment can also be a method, which is a programmed procedure that is defined as part of a class. In another embodiment, the code segment is a variable, which is a value that can change, depending on the conditions or information used in a program, that is used as data in a program. Furthermore, the code segment can be a function or a constant, wherein the function is similar to a method in that it is a programmed procedure that is used in a program. A constant can be a value that remains fixed and does not change.

A database is queried (e.g., by a processor) with the name of the code segment in the first language to identify the name of the code segment in a second language that is different from the first language 120. As used herein, the term “database” includes a computer hardware memory device. The database can include the names of code segments in a plurality of languages (this database is also referred to herein as the “first database”). In at least one embodiment, the second language is a default coding language (e.g., English) that is selected by a software development team. For example, a Spanish speaking developer inputs the name “Sistema.de”, which is eventually translated by the system to “System.out”.

In at least one embodiment of the invention, the system separates the name of the code segment in the first language into multiple words. This can be done based on capitalization of letters in the name of the code segment. For example, the processor separates the input “ottenereDifettoSessione” into the words “ottenere”, “Difetto”, and “Sessione”. Each of the separate words can be translated from the first language to the second language by querying the database with each word (in the first language). Thus, in the preceding example, the database is queried with each of the words “ottenere”, “Difetto”, and “Sessione” to identify the words “get”, “Default”, and “Session”, which are subsequently combined to identify the name “getDefaultSession”.

Having identified the name of the code segment in the second language (also referred to herein as the “translated name”), the name of the code segment in the second language can be displayed as an option to the user (e.g., on a display screen) 130A and/or the name of the code segment in the first language (i.e., the user input) can be replaced with the name of the code segment in the second language (e.g., with the processor) 130B.

In at least one embodiment of the invention, a database (e.g., the first database, or a separate database) is queried with the name of the code segment in the first language and/or the name of the code segment in the second language. This database (also referred to herein as the “second database”) includes a library of code segments (i.e., the pre-written lines of code corresponding to the code segment name(s)). The code segment is retrieved from the second database.

In at least one embodiment of the invention, each word in the name of the code segment is translated from the first language to the second language. For instance, in the example discussed above, the input “ottenereDifettoSessione” is broken down into the words “ottenere”, “Difetto”, and “Sessione”, which are translated to “get”, “Default”, and “Session”. Each of the translated words (i.e., in the second language) can be combined sequentially into a single word (e.g., “getDefaultSession”); and, the first and/or second database can be queried with the single word to retrieve the code segment.

In another embodiment of the invention, as described more fully below, the name of the code segment in the first language is displayed on a screen; and, the processor detects the presence of a mouse pointer or cursor over or proximate to the name of the code segment in the first language. As used herein, “proximate” is intended to mean near, adjacent, contiguous, next to, close to, by, on, in contact with, and the like. A text window (e.g., pop-up, pop-up window, dialog box, text box) can be displayed proximate the mouse pointer, wherein the text window includes the name of the code segment in the second language.

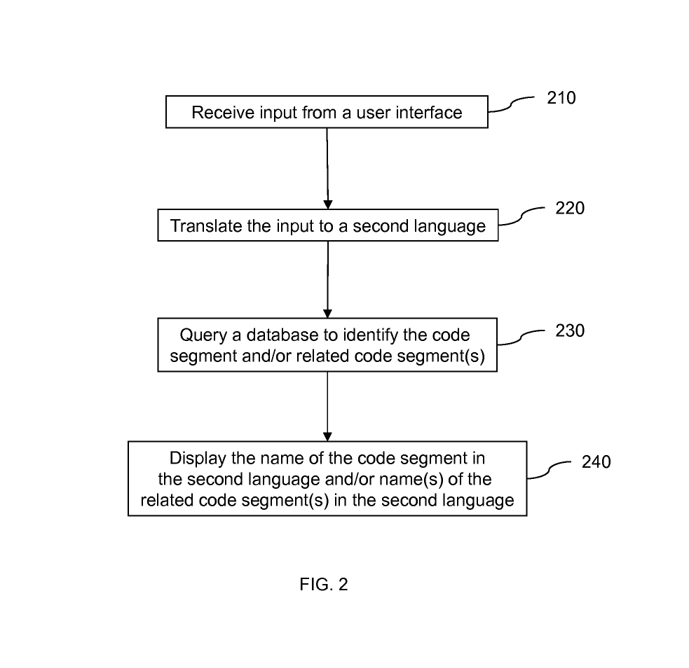

FIG. 2 is a flow diagram illustrating a method for native language IDE code assistance according to an embodiment of the invention. Input from a user interface is received (e.g., by a processor) 210, wherein the input includes the name of a code segment in a first language. A translation engine translates the name of the code segment from the first language to a second language different from the first language 220. As used herein, the term “translation engine” includes a hardware computer device for translating words between different languages.

A processor queries a database with the name of the code segment in the second language to identify the code segment and/or one or more code segments that are related to the code segment (also referred to herein as the “related code segment”) 230. The related code segment has a threshold degree of similarity with the code segment, the threshold degree of similarity including similarity in name (in the first or second language), similarity in description, and/or similarity in function. For example, the code segments “System.out”, “System.printIn”, and “System.err” are related code segments having a threshold degree of similarity in name, description, and function.

The name of the code segment in the second language and/or the name(s) of the related code segment(s) in the second language are displayed to the user (e.g., via a graphical user interface) 240. In at least one embodiment of the invention, the name of the code segment in the first language (e.g., ottenereDifettoSessione) is separated into multiple words based on capitalization of letters; each of the words are individually translated (e.g., translated from “ottenere”, “Difetto”, and “Sessione”); and, the database is queried with each of the translated words (e.g., “get”, “Default”, and “Session”).

In another embodiment, each word in the name of the code segment is translated from the first language to the second language. For example, “ottenere”, “Difetto”, and “Sessione” is translated to “get”, “Default”, and “Session”. Each of the translated words (in the second language) are combined sequentially into a single word (e.g., “getDefaultSession”); and, the database is queried with the single word.

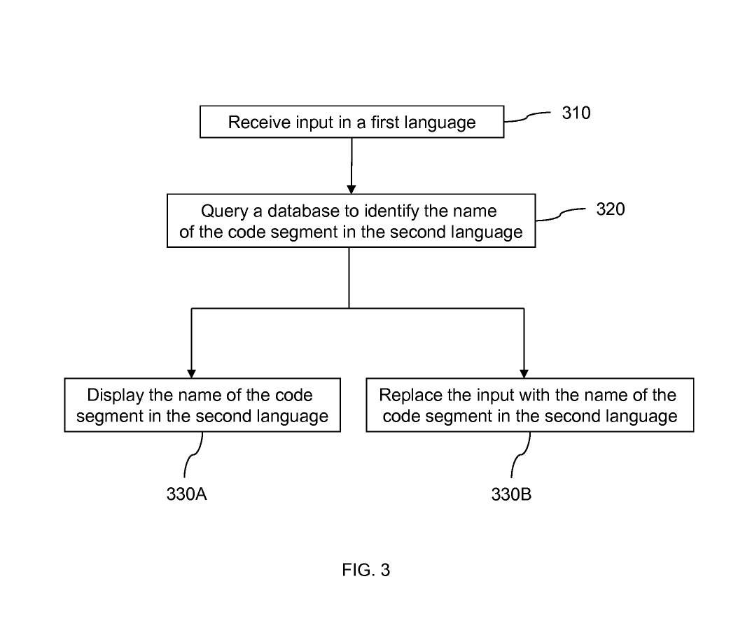

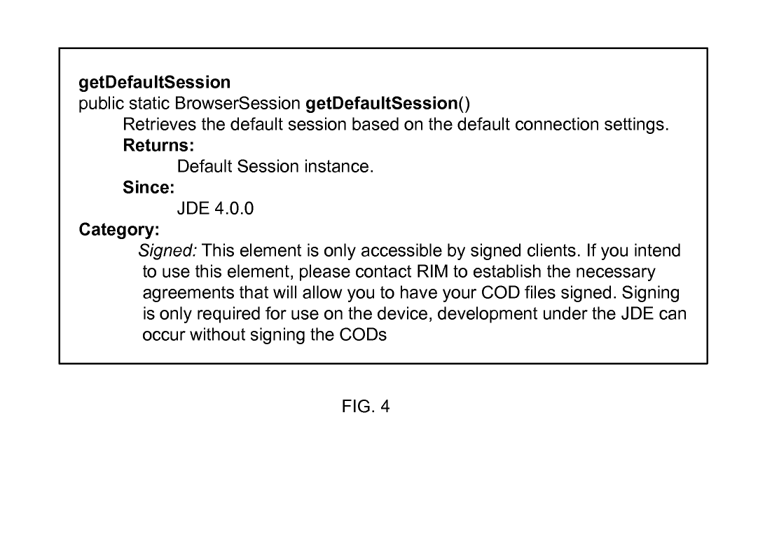

FIG. 3 is a flow diagram illustrating a method for native language IDE code assistance according to another embodiment of the invention. Input in a first language is received from a user interface 310, wherein the input includes a description of a code segment and/or a function of the code segment. For example, FIG. 4 illustrates the English description for the code segment “getDefaultSession( )” according to an embodiment of the invention. In at least one embodiment, the function for the code segment “getDefaultSession( )” is not the actual text of a possible method, such as “System.out”, but is the function the method would perform, such as “print to screen”, which would be matched to the method “System.out”. The input can be translated from the first language to a second language different from the first language (e.g., with a translation engine).

A database is queried with the input and/or the translated input (in the second language) to identify the name of the code segment in the second language 320. The database includes names of code segments in a plurality of languages, descriptions of the code segments in a plurality of languages, and/or functions of code segments in a plurality of languages. Having identified the name of the code segment in the second, the name of the code segment in the second language can be displayed as an option to the user (e.g., on a display screen) 330A and/or the name of the code segment in the first language (i.e., the user input) can be replaced with the name of the code segment in the second language (e.g., with the processor) 330B. In at least one embodiment, a second database is queried with the name of the code segment in the second language, wherein the second database includes a library of code segments in multiple languages. The code segment is retrieved from the second database.

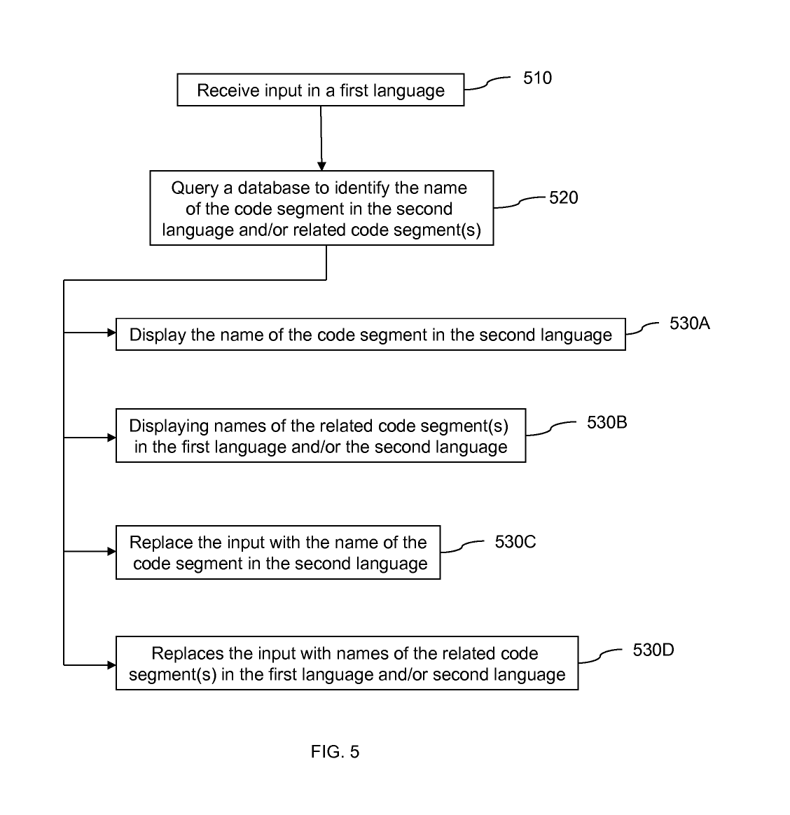

FIG. 5 is a flow diagram illustrating a method for native language IDE code assistance according to another embodiment of the invention. Input in a first language is received from a user interface 510, wherein the input includes a description of a code segment and/or a function of the code segment. The input can be translated from the first language to a second language different from the first language (e.g., with a translation engine).

A database is queried with the input and/or the translated input (in the second language) to identify the name of the code segment in the second language, and/or one or more related code segment(s) in the first language and/or second language 520. The database can include names of code segments in a plurality of languages, descriptions of code segments in a plurality of languages, and/or functions of code segments in a plurality of languages. The related code segment(s) have a threshold degree of similarity with the code segment, the threshold degree of similarity including similarity in name (in the first or second language), similarity in description, and/or similarity in function.

A processor displays the name of the code segment in the second language 530A, displaying names of the related code segment(s) in the first language and/or the second language 530B, replaces the input in the first language with the name of the code segment in the second language 530C, and/or replaces the input in the first language with names of the related code segment(s) in the first language and/or second language 530D.

In at least one embodiment, a second database is queried with the name of the code segment in the second language and/or names of the related code segment(s) in the first language and/or second language. The second database can include a library of code segments, wherein the code segment and/or the related code segment(s) are retrieved from the second database.

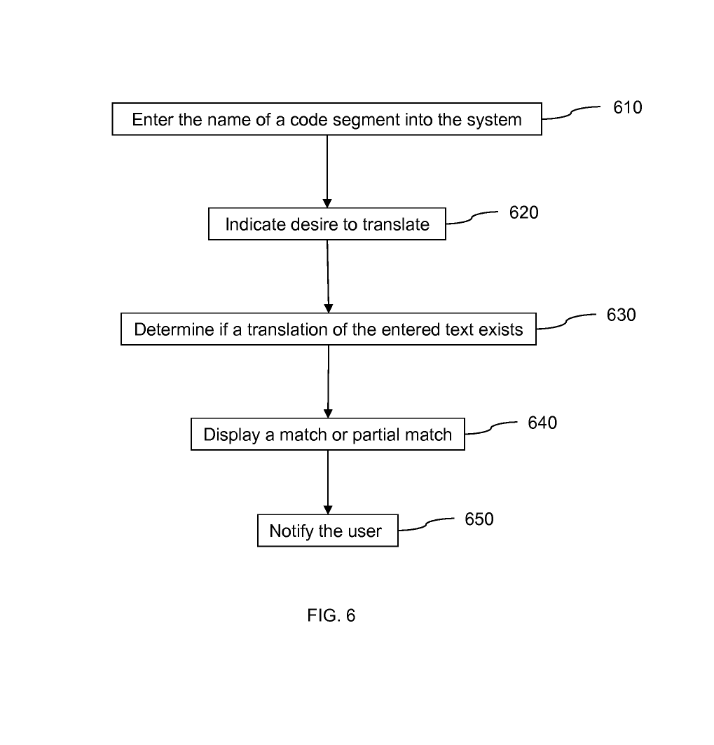

FIG. 6 is a flow diagram illustrating a method for code segment translation according to an embodiment of the invention. A user (also referred to herein as a “developer” or “programmer”) begins typing the name of a code segment in their native language into the system 610. The native language is a set preference that can be changed at any time. As used herein, the term “code segment” includes a class, a method, a variable, a function, and a constant.

The user then indicates that she would like the entered text to be translated 620. For example, the user can enter a key combination to initiate translation, such as Shift+Space (traditional eclipse type-ahead method population)+T (translate).

Alternatively, the user can select a menu option within the system, e.g., Menu>Translate. In another embodiment, the system (also referred to herein as the “IDE”) has a global setting that automatically translates when the user hits a specific key. For example, the text “Sistema” translates to “System” after the period key is activated (i.e., “.”), and the system suggests the names “System.out”, “System.err”, etc. The user may choose from those options to continue typing ex. de which results in System.out.printIn( ). There can be several ways of enabling a type-ahead function in an IDE. In at least one embodiment, when a user selects one of these tools (e.g., “SHIFT” and “SPACE”, or from the menu), types a word in his or her native language (e.g., “sistema”), and hits the period key (“.”), which is part of the method syntax, then the typed word would be automatically substituted (e.g., with “system.”). In another embodiment, the options of “system.out” and “system.err” are displayed to the user in the programming language. If the suggestions are not correct, then the user can continue typing letters.

After receiving the translation indication from the user, the system performs a lookup to determine if a translation of the entered text exists 630. Specifically, the system can query native language to development language translation dictionaries, e.g., Spanish to English. The system matches the translation options with available coding options, e.g., “System” matched with “System.out” and “System.err”.

If at least one match is found or a partial match is found by the system, the match (or partial match) is displayed to the user 640. In another embodiment, the match is auto populated into the code (i.e., the native language text is replaced with the matched text), where the native language text can be annotated to the matched text as a comment (e.g., Sistema de System.out.printIn(“ ”); //Sistema de). The matched text can be saved for quick replacement later. This can allow the system to skip items 530 and 540 in the future and perform replacements based on a saved user defined mapping. If no match is found, then the user is notified 650. If the user continues coding, then the system repeats item 510.

The following provides an example implementation of a method for code segment translation according to an embodiment of the invention. A native Spanish-speaking developer cannot remember the name in the default coding language (English) of the method in system to write a console statement. The developer begins typing, in Spanish, the method or call of interest. A lookup of the entered text is performed by the IDE; and, the code segment “System.out” is suggested to the developer. The developer selects the suggestion and the IDE replaces the developer's native language input with the valid compilation version in the default coding language.

In at least one embodiment, common translations across a team development environment are saved to create a team dictionary or common mapping suggestion for faster native language code assistance. In another embodiment, a programmer hovers his or her mouse over a help icon and the programmer's input is translated within the IDE directly.

Coding can use notation for identifying classes, methods, and variables, wherein the notation can break groups of characters apart with capital letters (first letter is lower case). For example, the code segment “getDefaultSession( )” is broken into its components: “get”, “Default”, and “Session”. In Italian, this is translated to: “ottenere”, “Difetto”, and “Sessione”, which results in “ottenereDifettoSessione( )”.

The descriptions of the methods can be translated as well. FIG. 4 illustrates the English description for the code segment “getDefaultSession( )” according to an embodiment of the invention. The IDE can translate the description of the method and the description of the Return.

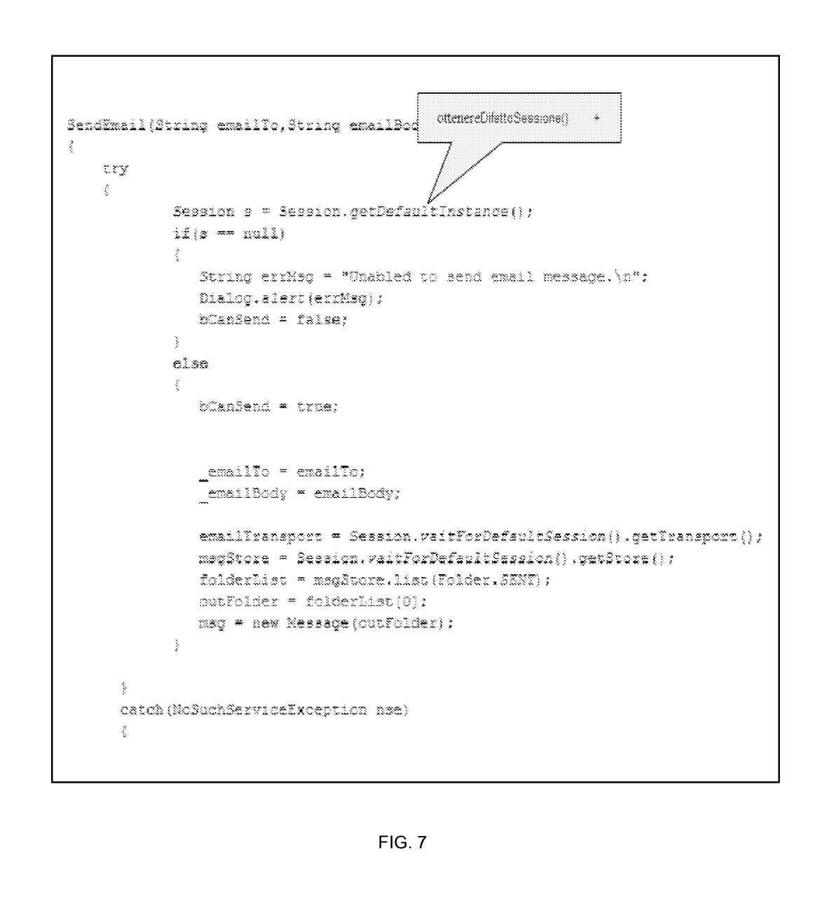

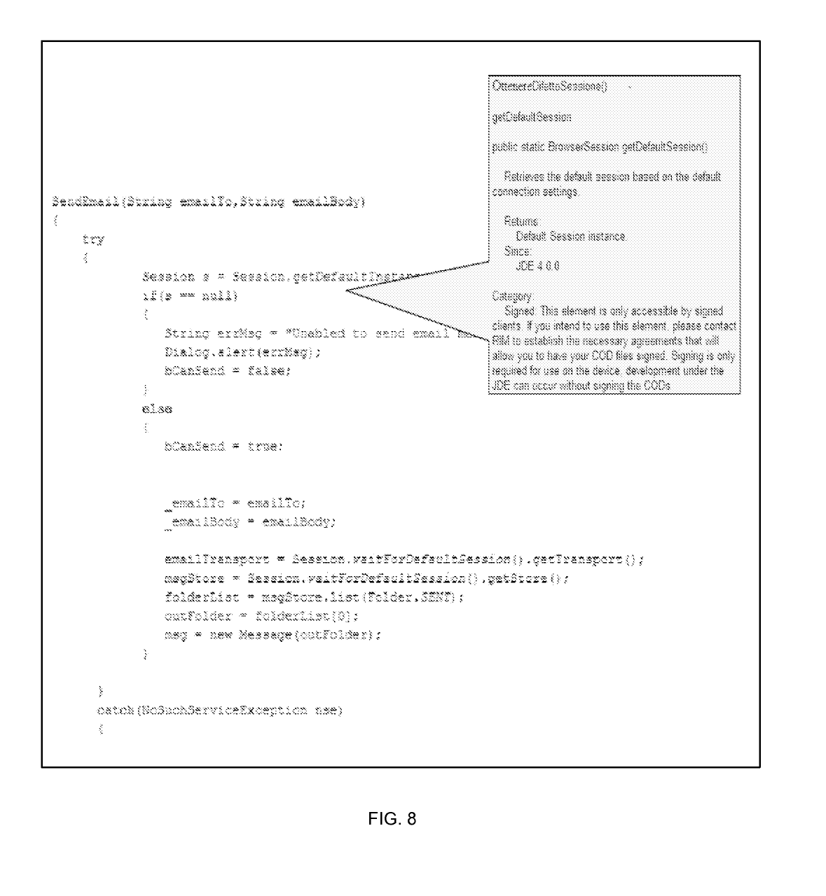

FIG. 7 illustrates an example code snipet in English according to an embodiment of the invention. Based on capitalization of the characters in the code segment, the IDE suggests the translated code segment “ottenereDifettoSessione( )” for the English code segment “getDefaultInstance( )”. As illustrated in FIG. 8, clicking on the “+” expander icon displays the description of the translated code segment. A programmer can select an option within the IDE to always view their code environment in their native language (reverse translation). No workspace or compilation errors would be displayed.

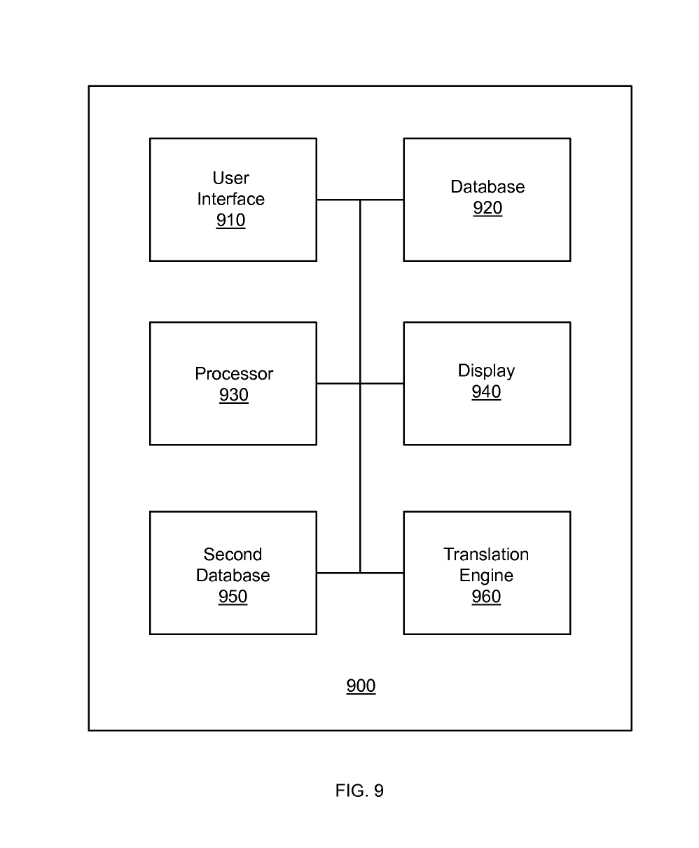

FIG. 9 illustrates a system 900 for native language IDE code assistance according to an embodiment of the invention, wherein the system 900 includes a user interface 910 connected to a database 920. As used herein, the term “connected” includes operationally connected, logically connected, in communication with, physically connected, engaged, coupled, contacts, linked, affixed, and attached. The user interface 910 can be a hardware computer component (e.g., keyboard, mouse, GUI) that receives input, the input including a name of a code segment in a first language. In at least one embodiment, the code segment includes pre-written lines of code in a computer program, such as, a class, a system, a variable, a function, and a constant. As used herein, the term “database” includes a computer memory device that stores electronic data. For example, the database 920 includes names of code segments in a plurality of languages.

The system 900 also includes a processor 930 connected to the database 910. As used herein, the term “processor” includes a hardware computer component that queries the database 910 with the name of the code segment in the first language to identify the name of the code segment in a second language different from the first language. The second language can be a default coding language selected by a software development team. The processor 930 displays the name of the code segment in the second language on a display 940 (e.g., monitor, touchscreen display) and/or replaces the name of the code segment in the first language with the name of the code segment in the second language.

The system 900 can further include a second database 950 and/or a translation engine 960, where the second database 950 includes a library of code segments. The processor 930 can query the second database 950 with the name of the code segment in the first language and/or the name of the code segment in the second language to retrieve the code segment from the second database 950.

As used herein, the term “translation engine” includes a hardware computer component that translates words from one language to another language. In at least one embodiment, the processor 930 separates the name of the code segment in the first language into multiple words based on capitalization of letters in the name of the code segment in the first language; and, the translation engine 960 translates each of the words from the first language to the second language.

In another embodiment, the translation engine 960 translates each word in the name of the code segment from the first language to the second language; and, the processor 930 combines each of the translated words in the second language sequentially into a single word. The processor 930 can query the second database 950 with the single word to retrieve the code segment.

In at least one embodiment of the invention, the processor 930 detects a mouse pointer over the name of the code segment in the first language (on the display 940). The processor 930 can display a text window on the display 940 that proximate the mouse pointer, wherein the text window includes the name of the code segment in the second language.

Another embodiment of the invention provides a system having a user interface to receive input in a first language, wherein the input includes a description of a code segment and/or a function of the code segment. The code segment can be a class, a system, a variable, a function, and/or a constant. A translation engine is provided that translates the input in the first language to translated input in a second language. The second language can be a default coding language selected by a software development team.

A database is connected to the user interface and a processor, wherein the database includes names of code segments in a plurality of languages, descriptions of code segments in a plurality of languages, and/or functions of code segments in a plurality of languages. The processor queries the database with the input and the translated input in the second language to identify the name of the code segment in the second language. The processor displays the name of the code segment in the second language and/or replaces the input in the first language with the name of the code segment in the second language.

A system according to another embodiment of the invention includes a user interface that receives input, the input including the name of a code segment (e.g., class, system, variable, function, constant) in a first language. A translation engine connected to the user interface translates the name of the code segment from the first language to a second language different from the first language.

In at least one embodiment, a processor separates the name of the code segment in the first language into multiple words based on capitalization of letters in the name of the code segment in the first language. The translation engine can translates each of the multiple words; and, a database can be queried by the processor with each of the translated multiple words. In another embodiment, the translation engine translates each word in the name of the code segment from the first language to the second language. The processor can combine each of the translated words in the second language sequentially into a single word, and query the database with the single word.

The processor is connected to the translation engine and queries the database with the name of the code segment in the second language to identify the code segment and/or one or more related code segments. The related code segment(s) have a threshold degree of similarity with the code segment, wherein the threshold degree of similarity can include similarity in name, similarity in description, and/or similarity in function.

A display is connected to the processor for displaying the name of the code segment in the second language and/or the name(s) of the related code segment(s). A second database having a library of code segments can be provided, where the processor queries the second database with the name of the code segment in the second language and/or the name(s) of the related code segment(s) in the second language to retrieve the code segment and the name(s) of the related code segment(s) from the second database.

In at least one embodiment, the processor detects a mouse pointer over the name of the code segment in the first language (on the display). The display can display a text window proximate the mouse pointer, wherein the text window includes the name of the code segment in the second language and/or name(s) of the related code segment(s) in the second language.

As will be appreciated by one skilled in the art, aspects of the present invention may be embodied as a system, method or computer program product. Accordingly, aspects of the present invention may take the form of an entirely hardware embodiment or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

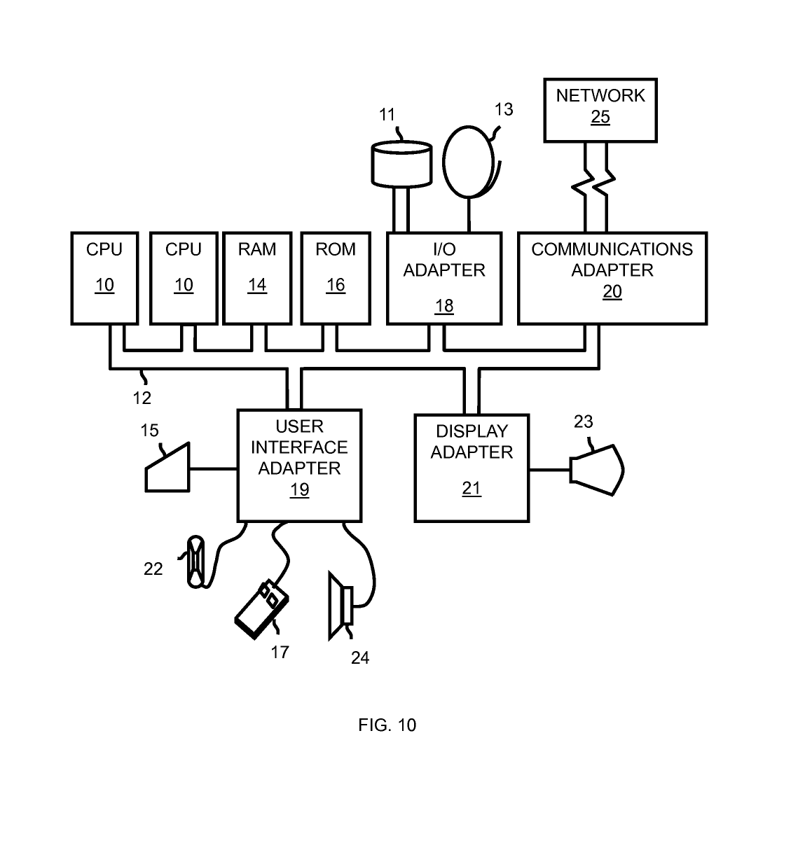

Referring now to FIG. 10, a representative hardware environment for practicing at least one embodiment of the invention is depicted. This schematic drawing illustrates a hardware configuration of an information handling/computer system in accordance with at least one embodiment of the invention. The system comprises at least one processor or central processing unit (CPU) 10. The CPUs 10 are interconnected with system bus 12 to various devices such as a random access memory (RAM) 14, read-only memory (ROM) 16, and an input/output (I/O) adapter 18. The I/O adapter 18 can connect to peripheral devices, such as disk units 11 and tape drives 13, or other program storage devices that are readable by the system. The system can read the inventive instructions on the program storage devices and follow these instructions to execute the methodology of at least one embodiment of the invention. The system further includes a user interface adapter 19 that connects a keyboard 15, mouse 17, speaker 24, microphone 22, and/or other user interface devices such as a touch screen device (not shown) to the bus 12 to gather user input. Additionally, a communication adapter 20 connects the bus 12 to a data processing network 25, and a display adapter 21 connects the bus 12 to a display device 23 which may be embodied as an output device such as a monitor, printer, or transmitter, for example.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the root terms “include” and/or “have”, when used in this specification, specify the presence of stated features, integers, steps, operations, elements, and/or components, but do not preclude the presence or addition of at least one other feature, integer, step, operation, element, component, and/or groups thereof.

The corresponding structures, materials, acts, and equivalents of all means plus function elements in the claims below are intended to include any structure, or material, for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A system comprising:
a user interface, said user interface receives input including a name of a code segment in a first language;
a database connected to said user interface, said database including names of code segments in a plurality of languages; and
a processor connected to said database, said processor queries said database with the name of the code segment in the first language to identify a name of the code segment in a second language different from the first language, said processor one of displays the name of the code segment in the second language and replaces the name of the code segment in the first language with the name of the code segment in the second language.

2. The system according to claim 1, wherein the code segment includes at least one of a class, a system, a variable, a function, and a constant.

3. The system according to claim 1, wherein the second language is a default coding language selected by a software development team.

4. The system according to claim 1, further comprising a second database including a library of code segments, wherein said processor queries said second database with at least one of the name of the code segment in the first language and the name of the code segment in the second language to retrieve the code segment from said second database.

5. The system according to claim 1, wherein said processor separates the name of the code segment in the first language into multiple words based on capitalization of letters in the name of the code segment in the first language,
wherein said system further comprises a translation engine that translates each of the words from the first language to the second language.

6. The system according to claim 1, further including a translation engine that translates each word in the name of the code segment from the first language to the second language,
wherein said processor combines each of the translated words in the second language sequentially into a single word, and queries a second database with the single word to retrieve the code segment.

7. The system according to claim 1, wherein said processor detects a mouse pointer over the name of the code segment in the first language, and displays a text window proximate the mouse pointer, the text window including the name of the code segment in the second language.

8. The system according to claim 1, wherein the code segment includes pre-written lines of code in a computer program.

9. A system comprising:
a user interface, said user interface receives input in a first language, the input including at least one of a description of a code segment and a function of the code segment;
a database connected to said user interface, said database including at least one of names of code segments in a plurality of languages, descriptions of code segments in a plurality of languages, and functions of code segments in a plurality of languages;
a processor connected to said database, said processor queries said database with at least one of the input and translated input in a second language to identify a name of the code segment in the second language, said processor one of displays the name of the code segment in the second language and replaces the input in the first language with the name of the code segment in the second language.

10. The system according to claim 9, wherein the code segment includes at least one of a class, a system, a variable, a function, and a constant.

11. The system according to claim 9, wherein the second language is a default coding language selected by a software development team.

12. The system according to claim 9, further including a translation engine that translates the input in the first language to the translated input in the second language.

13. A system comprising:
a user interface, said user interface receives input including a name of a code segment in a first language;
a translation engine connected to said user interface, said translation engine translates the name of the code segment from the first language to a second language different from the first language;
a processor connected to said translation engine, said processor queries a database with the name of the code segment in the second language to identify at least one of the code segment and at least one related code segment, the at least one related code segment having a threshold degree of similarity with the code segment; and
a display connected to said processor, said display displays at least one of the name of the code segment in the second language and names of the at least one related code segment.

14. The system according to claim 13, wherein the threshold degree of similarity with the code segment includes at least one of similarity in name, similarity in description, and similarity in function.

15. The system according to claim 13, wherein the code segment includes at least one of a class, a system, a variable, a function, and a constant.

16. The system according to claim 13, further including a second database including a library of code segments,
said processor queries said second database with at least one of the name of the code segment in the second language and the names of the at least one related code segment in the second language to retrieve at least one of the code segment and the at least one related code segment from said second database.

17. The system according to claim 13, wherein said processor separates the name of the code segment in the first language into multiple words based on capitalization of letters in the name of the code segment in the first language,
wherein said translation engine translates each of the multiple words, and
wherein said database is queried with each of the translated multiple words.

18. The system according to claim 13, wherein said translation engine translates each word in the name of the code segment from the first language to the second language,
wherein said processor combines each of the translated words in the second language sequentially into a single word, and
wherein said database is queried with the single word.

19. The system according to claim 13, wherein said processor detects a mouse pointer over the name of the code segment in the first language, and
wherein said display displays a text window proximate the mouse pointer, the text window including at least one of:
the name of the code segment in the second language, and
names of the at least one related code segment in the second language.

20. A computer program product comprising:
a non-transitory computer readable storage medium;
first program instructions to receive input including a name of a code segment in a first language;
second program instructions to query a database with the name of the code segment in the first language to identify a name of the code segment in a second language different from the first language, the database including names of code segments in a plurality of languages; and
third program instructions to one of display the name of the code segment in the second language and replace the name of the code segment in the first language with the name of the code segment in the second language.
wherein said first program instructions, said second program instructions, and said third program instructions are stored on said computer readable storage medium.
